(19) United States
(12) Patent Application Publication
(10) Pub. No.: US 2011/0148121 A1
(43) Pub. Date: Jun. 23, 2011

(54) SYSTEM AND METHOD FOR ELECTRICAL POWER GENERATION UTILIZING VEHICLE TRAFFIC ON ROADWAYS

(75) Inventor: Terry D. Kenney, Milpitas, CA (US)

(73) Assignee: AEST, Inc.

(21) Appl. No.: 12/643,838

(22) Filed: Dec. 21, 2009

(51) Int. Cl. F03G 7/08

(52) U.S. Cl. 290/1 R

(57) ABSTRACT

A power generation system is disclosed. According to one embodiment, the power generation system comprises a road plate assembly, a rocker arm coupled to the road plate assembly. The rocker arm undergoes a swinging motion by a downward motion of the road plate assembly caused by a vehicle passing over the road plate assembly. An electro-mechanical generator coupled to the rocker arm produces electricity by the swinging motion of the rocker arm.

### FIELD

The present invention relates to methods and systems for power generation. More particularly, the present invention is a method and system for power generation including electrical power generation utilizing vehicle traffic on roadways.

### BACKGROUND

Energy sources useful for the generation of electricity include wind, water, solar, nuclear and steam energy. Various methods and systems have been developed for harnessing such energy to generate electricity, typically by performing useful work to drive an electric generator.

With the continuing need for energy consumption efficiency and conservation, many efforts have been made to exploit previously unused energy sources. In particular, prior systems have been developed to use the energy and downward force of the wheels of vehicles as they move along a roadway surface.

Mechanical systems for generating electric power from the downward force of vehicles passing over a roadway typically involve gear mechanisms and other moving parts and are prone to wear and tear from the stress of forced downward movement in response to vehicles and forced upward movement when being reset. One example is U.S. Pat. No. 4,238,687 to Martinez, which discloses a system for generating electric power from the passage of motor vehicles over a roadway using turbines that are driven by the downward rotational movement of arc-shaped arms connected to rocker plates installed on a road surface when such rocker plates are forced down by vehicles passing over them.

More recent efforts include U.S. Pat. No. 6,172,426 to Galich, which discloses an energy platform system for generating electrical energy from the weight of a moving vehicle having a fluid bed containing a volume of fluid which is compressible by the weight of a moving vehicle driven over it. Fluid forced from within the bladder as a result of such compression passes through a circulation system where the moving fluid is used to drive a generator. The circulation assembly has an accumulator connected to the bladder that receives the forced fluid and releases it at a specified pressure level. A hydraulic pump and reservoir are also used. The electrical generator is a linear generator, comprising an elongate cylinder having a hollow interior. The exterior of the cylinder has a coil around it. A rod is inserted within the cylinder and has a magnet slidably coupled to it. As the rod in the cylinder is moved by the hydraulic fluid, the magnet moves as well, causing an electrical current within the coil.

U.S. Pat. No. 6,204,568 to Runner discloses a system for converting mechanical motion of vehicles into electrical energy using a plurality of motion converter assemblies. The motion converter assemblies include a rod that connects to a vertical motion delivery mechanism through a gearing mechanism for rotating the rod in response to vehicle traffic passing over the system. Fluid pumps are connected to the rotating rod to generate pressurized fluid which in turn drives a turbine generator. The motion converter assemblies have a rectangular base and sides forming a box and are inserted in the road surface. The motion converter assemblies also have a pair of rectangular top plates that are pivotally connected at one end to one side of the motion connection assembly base, with springs urging the plates upward. The top plate has a vertical plate pivotally connected to its under side which has teeth to engage a gear. When a vehicle passes over the top plate of a motion converter assembly, the vertical plate is driven downward and engages the gear, which rotates and drives the fluid pumps.

These prior systems, while in principle generate electrical power from the downward force of vehicles as they pass over a roadway, are inefficient in their ability to maximize the electrical power generated from each passing vehicle. Vehicles have varying weights; the downward force of a semi-truck is considerably more than that of a compact car. Prior systems do not effectively harness the full force of each vehicle. Additionally, because vehicle traffic is typically irregular, there is an increased need in such a system to maximize the transfer of energy from each vehicle and store energy to provide a steady supply of electric power.

### SUMMARY

A power generation system is disclosed. According to one embodiment, the power generation system comprises a road plate assembly, a rocker arm coupled to the road plate assembly. The rocker arm undergoes a swinging motion by a downward motion of the road plate assembly caused by a vehicle passing over the road plate assembly. An electro-mechanical generator coupled to the rocker arm produces electricity by the swinging motion of the rocker arm.

The above and other preferred features, including various novel details of implementation and combination of elements will now be more particularly described with reference to the accompanying drawings and pointed out in the claims. It will be understood that the particular methods and apparatus are shown by way of illustration only and not as limitations. As will be understood by those skilled in the art, the principles and features explained herein may be employed in various and numerous embodiments

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1A illustrates an exemplary power generation system in a retracted position, according to one embodiment;

FIG. 1B illustrates an exemplary power generation system in an extended position, according to one embodiment;

FIG. 2 illustrates an exemplary linear generator, according to one embodiment;

FIG. 3 illustrates an exemplary power station, according to one embodiment;

FIG. 4 illustrates a top view of an exemplary power generation system, according to one embodiment; and

FIG. 5 illustrates a cross-sectional view of an exemplary power generation system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A power generation system is disclosed. According to one embodiment, the power generation system comprises a road plate assembly, a rocker arm coupled to the road plate assembly. The rocker arm undergoes a swinging motion by a downward motion of the road plate assembly caused by a vehicle passing over the road plate assembly. An electro-mechanical generator coupled to the rocker arm produces electricity by the swinging motion of the rocker arm. According to one embodiment, the electro-mechanical generator comprises a tube assembly, a core assembly having one or more magnets on its surface, and a pushrod. The pushrod is coupled to the core assembly on one end and coupled to the rocker arm on the other end. The core assembly slidably moves in and out of the tube assembly undergoing a linear motion by the swinging motion of the rocker arm. The electro-mechanical generator produces electricity by the linear motion of the core assembly.

In the following description, for purposes of clarity and conciseness of the description, not all of the numerous components shown in the schematic are described. The numerous components are shown in the drawings to provide a person of ordinary skill in the art a thorough enabling disclosure of the present invention. The operation of many of the components would be understood and apparent to one skilled in the art.

Each of the additional features and teachings disclosed herein can be utilized separately or in conjunction with other features and teachings to provide a linear generator system. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the claims. Therefore, combinations of features disclosed in the following, detailed description may not be necessary to practice the teachings in the broadest sense, and are instead taught merely to describe particularly representative examples of the present teachings.

Moreover, the various features of the representative examples and the dependent claims may be combined in ways that are not specifically and explicitly enumerated in order to provide additional useful embodiments of the present teachings. In addition, all features disclosed in the description and/or the claims are intended to be disclosed separately and independently from each other for the purpose of original disclosure, as well as for the purpose of restricting the claimed subject matter independent of the compositions of the features in the embodiments and/or the claims. All value ranges or indications of groups of entities disclose every possible intermediate value or intermediate entity for the purpose of original disclosure, as well as for the purpose of restricting the claimed subject matter. The dimensions and the shapes of the components shown in the figures are designed to help to understand how the present teachings are practiced, but not intended to limit the dimensions and the shapes shown in the examples.

One embodiment provides a system and method for electrical power generation utilizing vehicle traffic on roadways. The system may have several components such as a road plate assembly having one or more steps and/or arms coupled to one or more electro-mechanical generators that are actuated when vehicles pass over the road plate assembly.

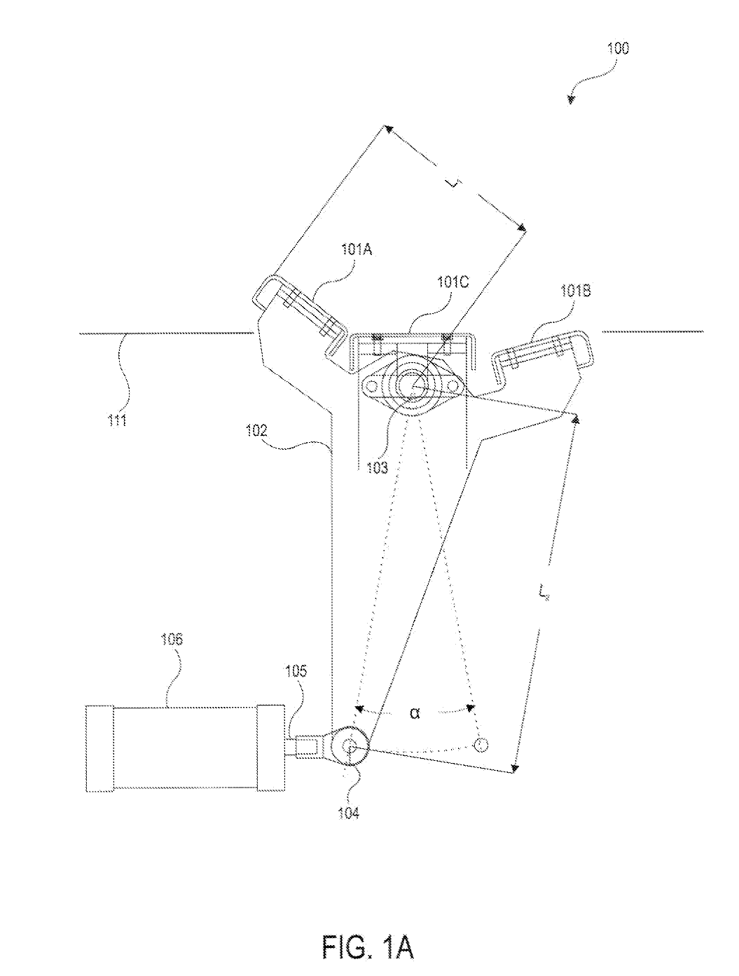

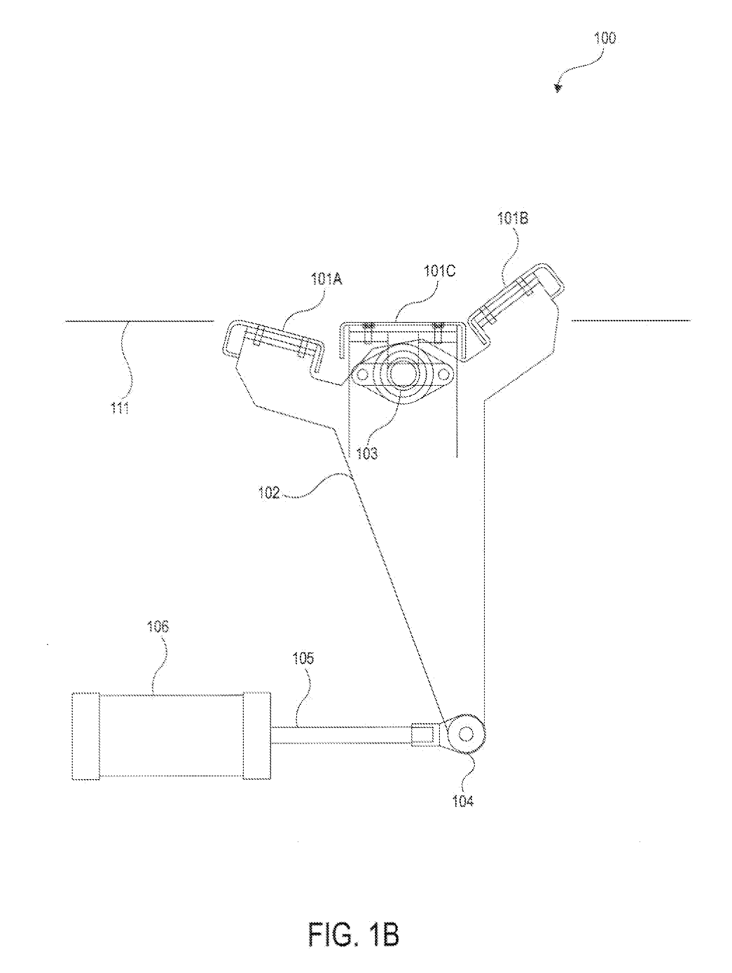

FIG. 1A illustrates an exemplary power generation system, according to one embodiment. Power generation system 100 has road plates 101A, 101B, and 101C, rocker arm 102, and generator 106 coupled to rocker arm 102 via pushrod 105. Road plate assembly 101 is designed to leverage the downward force generated by a vehicle passing over it. Road plate assembly 101 may have several road plates or several road plate assemblies 101 may be used in series.

In the example as illustrated in FIG. 1A, road plates 101A; 101B, and 101C form a road plate assembly 101. Road plate WIC located at the center of the assembly is stationary and is preferably level with road surface 111. Road plates 101B and 101C are designed to move up and down as a vehicle passes over them as will be discussed in greater detail below. Road plate assembly 101 is constructed from welded aluminum or steel, although other rigid and durable materials such as plastics, fiberglass and other metals and composite materials may be utilized. Road plate assembly 101 may be installed in sections on a roadway with minimal damage to the roadway to conform to the road surface 111.

Road plates 101A and 101B are coupled to rocker arm 102, and road plate 101C is decoupled from rocker arm 102, according to one embodiment. One end of rocker arm 102 is coupled to pushrod 105 using pushrod end 104. When a vehicle passes over road plate assembly 101, the wheels of the vehicle contact and press road plates 101A, 101B, and 101C in a particular sequence. If a vehicle moves across road surface 111 from right to left, the wheel contacts a first road plate 101B and presses on the front part of the entering road plate. The pushing on the first road plate 101B causes pushrod 105 to retract. As the wheel move across the road plate assembly 101, the wheel presses a second road plate 101A causing pushrod 105 to extend. This process is repeated for each wheel and each axel of the vehicle. FIGS. 1A and 1B show the configuration of generator 106 in a retracted position and an extended position, respectively.

For example, if a vehicle drives by from the right side to the left side of FIG. 1A, the wheels of the vehicle touch the road plates in the order of 101B, 101C, and 101A. When the wheels press road plate 1018, rocker arm 102 and pushrod 105 are positioned as shown in FIG. 1A. As the wheels go over road plates 101C and subsequently 101A, rocker arm 102 is forced to swing around pivot point 103 causing pushrod 105 to extend as shown in FIG. 1B. The next wheels press down road plates 101B causing pushrod 105 to retract as shown in FIG. 1A. The repeated linear movements of the pushrod 105 in and out of generator 106 generate electricity.

According to one embodiment, the dimensions and sizes of the components of power generation system 100 are determined and optimized based on various factors. For example, the width and length of road plates 101a, 101b, and 101c, road plate lever arm L₁, rocker arm lever arm L₂, and the sweeping angle α of rocker arm 102 are determined by the wheel dimensions and the distance between axels of the targeted vehicles. A study may be conducted prior to the deployment of power generation system 100 in the field. Alternatively, vehicles of similar types and weights may be routed to a specific power generation system 100 designed to maximize power generation for routed vehicles. For instance, dump trucks with a wheel diameter of 38 inches or larger may be routed to a power generation system 100 having the road plate lever arm L₁ of 13.39 inches, rocker arm lever arm L₂ of 27.437 inches, and sweeping angle α of rocker arm 102 of 21 degrees. Other vehicles with smaller wheel diameters may be routed to another power generation system 100 with a shorter road plate lever arm L₁ and rocker arm lever arm L₂. Vehicle routing may be determined by other factors such as the vehicle's speed or weight per axle. The wheel size, ground clearance and the weight of the vehicle are among many factors to determine the dimensions and configuration of power generation system 100.

The mechanical actuation of road plates 101A or 101B, and 101C leaves road plate assembly 101 at a position where the last vehicle exits. Alternatively, a spring mechanism may be implemented in a one-way traffic to return road plate assembly 101 to a designated position. After a vehicle passes from left to right of FIG. 1A, push rod 105 remains extended as FIG. 1B. When the next vehicle passes over road plate assembly 101, push rod 105 is retracted and extended again as the next wheels pass over.

According to one embodiment, the height of either road plate 101A or 101B with respect to road surface 111 is determined to compromise ride comfort and speed reduction of the passing vehicles. If the elevated height is set too high, the speed bumps formed by a series of road plate assemblies would be too harsh for the drivers and it may result in excessive speed reduction, which is undesirable. On the other hand, if the elevated height is set too low, too little energy will be generated. Road plate assembly 101 is positioned at an optimized level between the elevated position and the recessed position of road plates 101A and 101B while maximizing energy generation and minimizing energy loss in a non-convertible form such as sound, heat. The elevated height and the lever arm ratio L₁/L₂ are among many design parameters of power generation system 100. The design parameters are determined to maximize power generation within the freedom of the choice of the design parameters.

According to one embodiment, the elevated heights for road plates 101A and 101B are symmetric and set equal. It is advantageous over an asymmetric design in that vehicle traffic in either direction (i.e., right to left, or left to right) can be used. The symmetric design would also be cheaper in material cost as the same parts for either traffic direction may be used. Alternatively, an asymmetric road plate design may be used if the asymmetry in design results in generating more energy in a particular direction. The asymmetric road plate design may be useful for deployment on a specific part of the road. For example, asymmetric road plates may be deployed on a down sloped road. The speed reduction caused by the bump formed by road plate assembly 101 is naturally restored by gravitational acceleration of the down slope. In addition, the speed reduction due to the hump will provide natural braking of the vehicle on the down sloped road.

There are several factors that affect the power output of power generation system 100. The mechanical energy from a downward force applied onto road plate assembly 101 by a passing vehicle is based on the weight of the passing vehicle, at each wheel or axel, acting on lever arms, L₁ and L₂. The mechanical force is independent of the speed of passing vehicles as it is calculated by the kinematics of the system. The force applied to generator 106 is calculated by:

$${F}_{generator} = {F}_{applied} * \frac{{L}_{1}}{{L}_{2}} ,$$

where F_{applied} is the force applied to road plate assembly 101. The point of the downward force is presumed to be at the tip of the road plates 101A or 101B as shown in FIG. 1A. No dynamic equations, e.g., the inertia of moving parts, the energy lost in the mechanical links, etc. have been considered to the calculation. This equation is useful for calculating the power rating of power generation system 100.

Another factor that determines the power generation by power generation system 100 is the vehicle speed. The kinetic energy of a moving vehicle increases with the square of its speed. The speed reduction of a vehicle when passing over road plate assembly 101 is related to the maximum kinetic energy that is collected by generator 106. Only a portion of the kinetic energy caused by the reduction of speed is converted by generator 106. The time interval of the linear stroke of pushrod 105 is determined by the vehicle speed. Table 1 shows the time for generator 106 to complete a single stroke for a ten-wheeled dump truck. When the truck approaches at 15 MPH. it takes 0.0457 second to complete the single stroke, which is equivalent to approximately 1313 revolution per minute (RPM) for a rotary generator.

TABLE 1

| Truck Speed | Velocity of | Velocity at | Time for Generator |
|---|---|---|---|
| in | Truck in | Generator in | to Complete One |
| Miles/Hour | Inches/Second | Inches/Second | Stroke in Seconds |
| 1 | 17.60 | 14.5792 | .6859 |
| 2 | 35.20 | 29.1584 | .3430 |
| 3 | 52.80 | 43.7376 | .2286 |
| 4 | 70.40 | 58.3168 | .1715 |
| 5 | 88.00 | 72.8960 | .1372 |
| 6 | 105.60 | 87.4751 | .1143 |
| 7 | 123.20 | 102.0543 | .0989 |
| 8 | 140.80 | 116.6335 | .0857 |
| 9 | 158.40 | 131.2127 | .0762 |
| 10 | 176.00 | 145.7919 | .0686 |
| 11 | 193.60 | 160.3711 | .0624 |
| 12 | 211.20 | 174.9503 | .0572 |
| 13 | 228.80 | 189.5295 | .0528 |
| 14 | 246.40 | 204.1087 | .0490 |
| 15 | 264.00 | 218.6879 | .0457 |
| 16 | 281.60 | 233.2671 | .0429 |
| 17 | 299.20 | 247.8463 | .0403 |
| 18 | 316.80 | 262.4254 | .0381 |
| 19 | 334.40 | 277.0046 | .0361 |
| 20 | 352.00 | 291.5838 | .0343 |
| 21 | 369.60 | 306.1630 | .0327 |
| 22 | 387.20 | 320.7422 | .0312 |
| 23 | 404.80 | 335.3214 | .0298 |
| 24 | 422.40 | 349.9006 | .0286 |
| 25 | 440.00 | 364.4798 | .0274 |

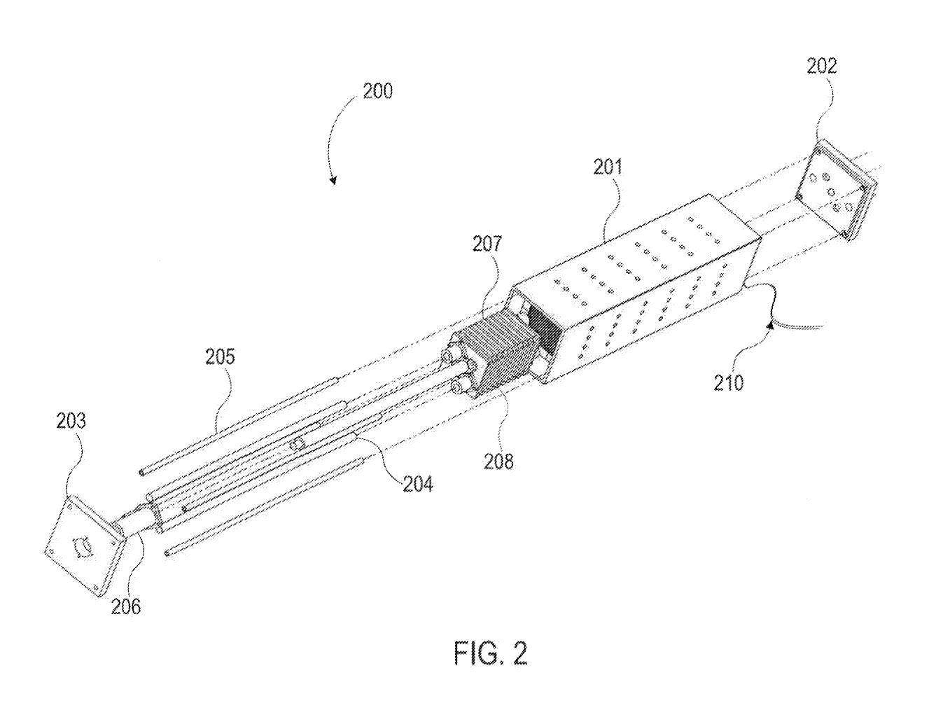

FIG. 2 illustrates an exemplary linear generator, according to one embodiment. Linear generator 200 includes tube assembly 201, core assembly 207, end plates 202 and 203, linear hearing 206, connecting rods 205 and hearing shall 204. Core assembly 207 is slidably disposed within tube assembly 201 and has permanent magnets 208 on its outer surface(s). Electrical coils 209 are arranged within tube assembly 201, and electrical lines 210 coupled to electrical coils 209 are connected to external wires for transmitting electricity generated by linear generator 200.

The energy generated by linear generator 200 is dependent on the velocity of the core assembly 207 sliding in and out of tube assembly 201. The velocity of the core assembly 207 is directly proportional to the velocity of the passing vehicle due to the kinematics of power generation system 100. As the velocity of a passing vehicle increases, so does the speed of core assembly 207 causing the increase of power output.

The number of linear generators 200 used, as well as their design, size and force handling capacity can vary and can be configured to meet the needs of the desired application. A plurality of linear generators 200 may be coupled to an electrical bus for collecting the electrical output from each of the generators. Alternate designs or conventional generators may be used in combination or in conjunction with one or more linear generators 200.

As a vehicle passes over a road plate assembly 101, rocker arm 120 swings, and the swing motion of rocker arm 102 coupled to the road plate assembly 101 causes pushrod 105 to slide in and out of tube assembly 201. The linear motion of pushrod 105 in and out of tube assembly 201 generates an electrical current in electrical coils 209 by magnetic induction. The electrical current is used to charge an electrical energy storage device, such as a battery or capacitor, or delivery to an electrical utility supply grid.

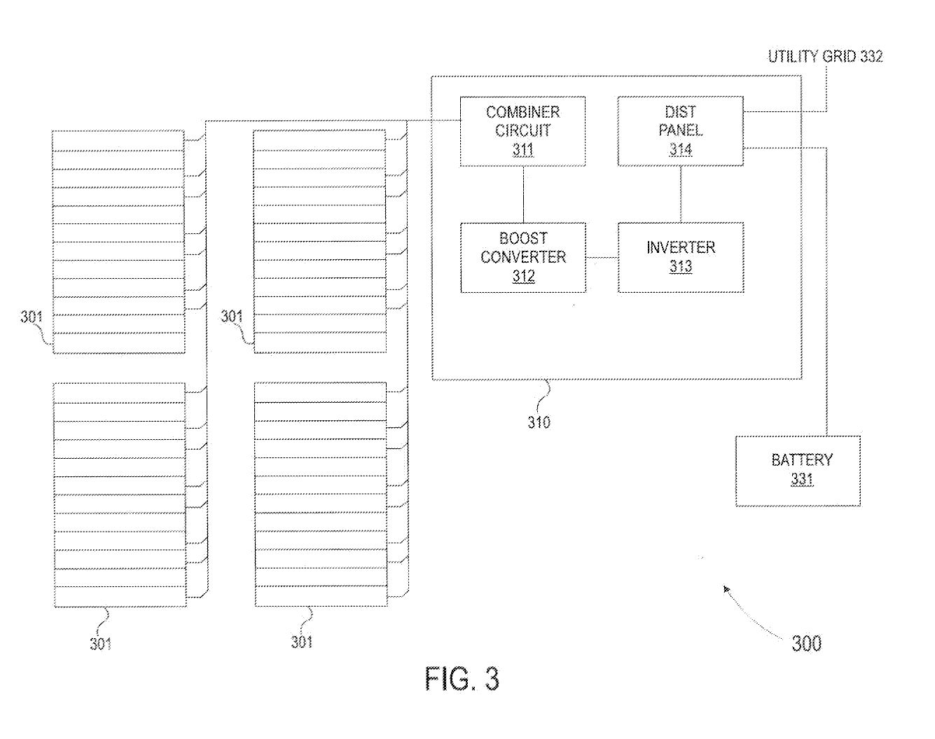

FIG. 3 illustrates an exemplary power station, according to one embodiment. Power station 300 includes one or more power generation systems 301. One or more power generation systems 301 may be grouped together to form a power grid. In the present example, four power generation systems 301 are shown for illustration purpose, but any number of power generation systems 310 may be used. Electricity generated by each power generation system 301 is sent to facility junction box 310, where the electricity from the power generation systems 310 is filtered, boosted, and converted into a suitable form. Combiner circuit 311 of facility junction box 310 receives electricity from each power generation system 301. The electricity is amplified to a higher voltage by boost converter 312. The DC output from boost converter 312 is converted into AC by inverter 313. Distribution panel 314 facilitates distribution of the AC output of inverter 313 to one or more energy storage devices 331, such as a battery or capacitor, and/or utility supply grid 332. When an energy storage device 331 reaches its maximum capacity, inverter 313 is engaged to route electricity to utility supply grid 332.

The operation of power station 300 relies on vehicles passing over road plate assemblies of each power generation system 301. The linear generators are actuated when vehicles pass over the coupled road plate assemblies. The downward motion of the road plate is converted into electricity by magnetic induction, and the generated electricity is sent to one or more energy storage devices 331 and/or utility supply grid 332.

According to one embodiment, each power generation system 301 is equipped with a road plate sensor designed to detect the velocity of passing vehicles and translate that velocity into a digital or analog electrical signal. Alternatively, the road plate sensor may detect the weight of the vehicle. The information obtained from the road plate sensor is used to dynamically configure power station 300 to maximize the electrical power generated from the passing vehicles. This dynamic configuration technique might be used in conjunction with a power generation system disclosed in U.S. Pat. No. 7,530,761, or a Pub. No. 2009/0179433, herein incorporated in their entirety by reference.

According to one embodiment, one or more power generation systems 301 are coupled to a hydraulic power generation system. Alternatively, a plurality of hydraulic power generation systems may be interconnected to a power generation system 301. Each hydraulic power generation system includes, but not limited to, (1) a reservoir to contain a supply of hydraulic fluid, (2) one or more hydraulic cylinders, (3) a flow divider designed to increase the pressure and reduce the volume of the hydraulic fluid expelled by the hydraulic cylinders, (4) a hydraulic fluid accumulator for storing hydraulic fluid at a high pressure, (5) a kick-down valve which releases the high-pressure hydraulic fluid from the accumulator when the pressure in the accumulator reaches a predetermined level, (6) a hydraulic motor which is fed high-pressure hydraulic fluid from the accumulator through the kick-down valve, and (7) an electric generator which is driven by the hydraulic motor.

According to one embodiment, one or more power generation systems 301 are coupled to a flywheel (not shown). A flywheel is used as a parasitic energy reservoir to provide consistent and smooth power input to the power generation system 301. During a peak power generation period, there is excessive kinetic energy that cannot be directly converted to electricity due to the limited capacity for energy conversion of power generation system 301. The excessive energy may be temporarily transferred in the form of kinetic energy of the flywheel, and is later converted to electricity when power generation system 301 falls below the maximum power generation capacity. The energy stored in the flywheel may be diverted to another power generation system or be directly consumed by a coupled power device.

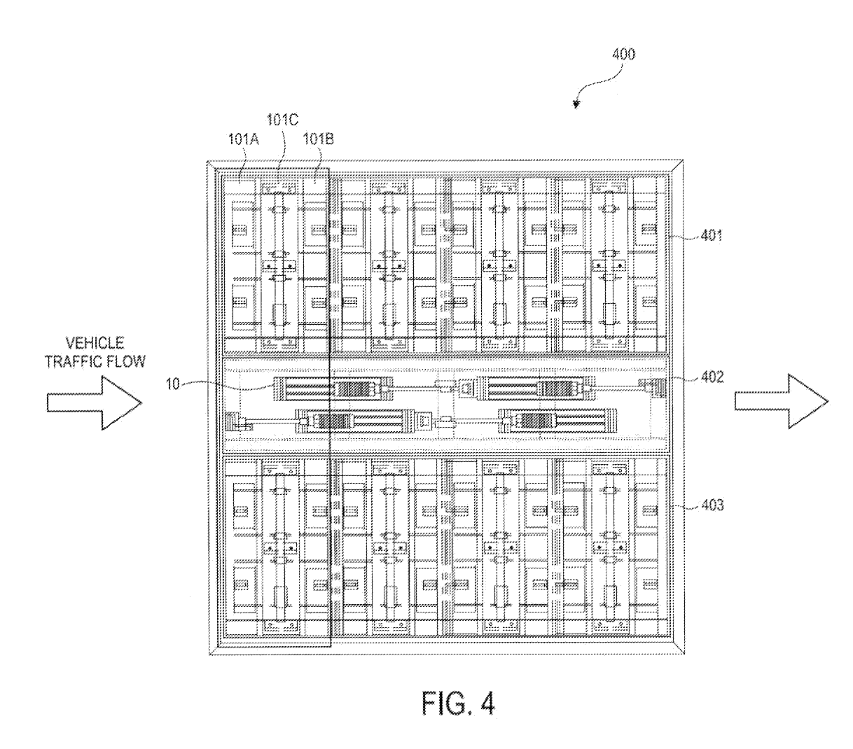

FIG. 4 illustrates a top view of an exemplary power generation system, according to one embodiment. Power generation system 400 contains four power generation systems 100 connected in series. Road plate assemblies are divided into left section 401 and right section 403 separated by mid section 402. Below mid section 402, generators 106 are stowed. Shown from above, only road plates 101A, 101B and 101C are visible and all the other components and systems (e.g., generators 106, rocker arms 102) are disposed below road surface 111. In one embodiment, four road plate assemblies 101 are laid in series, however a different number of road plate assemblies 101 may be used and the road plate assemblies 101 may be separately grouped. It is appreciated that the layout and configuration of road plate assemblies may vary without deviating from the scope of the present subject matter.

According to one embodiment, each of the road plates of left section 401 and right section 403 are coupled to a crankshaft. One or more crankshafts may be coupled to each other using a coupler. The crankshafts are connected to a push rod 105 and generate electricity by the in-and-out motion of push rod 105 with respect to the tube assembly 201. If a vehicle perpendicularly enters a road plate assembly, the left wheels and right wheels of the vehicle would touch road plates of left section 401 and right section 403 relatively simultaneously. The synchronized downward actions of the left and right road plate assemblies 101 are coupled by the coupler, and the combined actions are transmitted to same linear generator 200. According to another embodiment, the road plates of left section 401 and right section 403 may be operated independently. In that case, each side of road plates is coupled to a separate liner generator 200. According to yet another embodiment, more than one road plate may be coupled with a coupler.

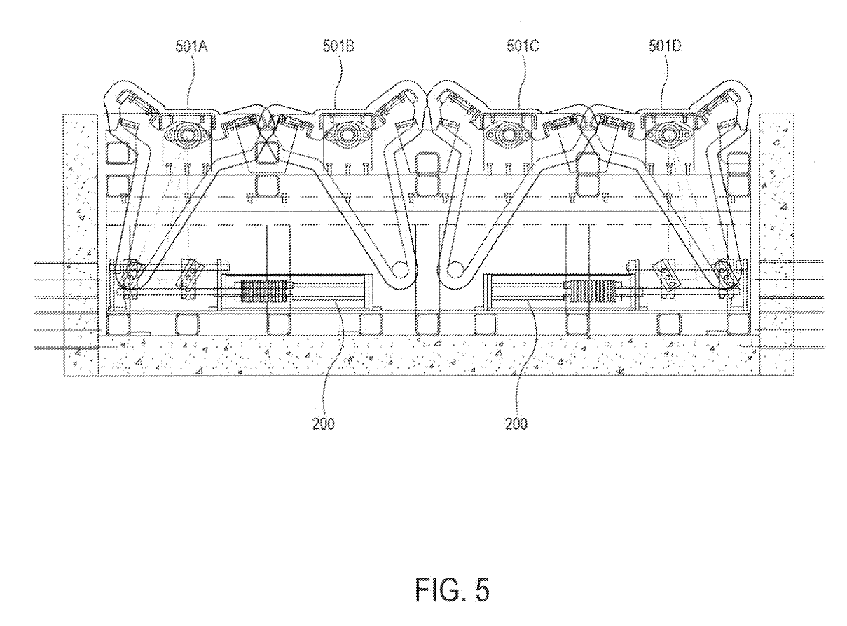

FIG. 5 illustrates a cross-sectional view of an exemplary power generation system 400, according to one embodiment. Power generation system 400 is installed underground. The surface of road plate assemblies 501A, 501C, 501C, and 501D are level with road surface 111. As a vehicle passes from left to right, road plate assemblies 501A, 501C, 501C, and 501D are pushed downward in sequence causing the coupled rocker arms to swing and the associated linear generators to extend and retract.

The present power generation system is designed to capture as much energy as possible from each vehicle of different weight traveling at various speeds. Power station 300 is preferably placed at a location where vehicle traffic is frequent, consistent, and predictable. Preferred locations for installation may include ports, cargo stations, weighing stations, parking garages, shopping center or recreation/amusement park parking lots and similar locations with relatively steady vehicle traffic. These examples are merely given to describe a practical application of the present subject matter, but are not intended to limit thereto. It is appreciated that other locations and applications may be applied without deviating from the scope of the present subject matter.

While the present system has been shown and described herein in what is considered to be the preferred embodiments thereof, illustrating the results and advantages over the prior art obtained through the present invention, the invention is not limited to the specific embodiments described above. Thus, the forms shown and described herein are to be taken as illustrative and other embodiments may be selected without departing from the spirit and scope of the present invention.

Embodiments as described herein have significant advantages over previously developed implementations. As will be apparent to one of ordinary skill in the art, other similar apparatus arrangements are possible within the general scope. The embodiments described above are intended to be exemplary rather than limiting and the bounds should be determined from the claims.

What is claimed is:

1. A power generation system comprising:
a road plate assembly;
a rocker arm coupled to the road plate assembly, wherein the rocker arm undergoes a swinging motion by a downward motion of the road plate assembly caused by a vehicle passing over the road plate assembly; and
an electro-mechanical generator coupled to the rocker arm, wherein the electro-mechanical generator produces electricity by the swinging motion of the rocker arm.

2. The power generation system of claim 1, wherein the electro-mechanical generator comprises:
a tube assembly;
a core assembly having one or more magnets on its surface; and
a pushrod having two ends, the pushrod being coupled to the core assembly on one end of the two ends and coupled to the rocker arm on the other end of the two ends,
wherein the core assembly slidably moves in and out of the tube assembly undergoing a linear motion by the swinging motion of the rocker arm, and
wherein the electro-mechanical generator produces electricity by the linear motion of the core assembly.

3. The power generation system of claim 1, wherein the road plate assembly comprises one or more road plates.

4. The power generation system of claim 3, wherein at least one road plate of the one or more road plates is stationary and leveled to a road surface.

5. The power generation system of claim 1, wherein the rocker arm swings about a pivot point underneath the road plate assembly.

6. The power generation system of claim 1, wherein more than one road plate assemblies are coupled to the electro-mechanical generator.

7. The power generation system of claim 1 further comprises a boost converter.

8. The power generation system of claim 7 further comprises an inverter.

9. The power generation system of claim 8 further comprises a distribution panel.

10. The power generation system of claim 1 further comprises a battery.

11. The power generation system of claim 1, wherein the electro-mechanical generator is further coupled to a flywheel.

12. The power generation system of claim 1 further comprises a hydraulic power generator coupled to the road plate assembly.

13. A power generation station comprising:
one or more power generation system, each of the one or more power generation
system comprising:
a road plate assembly;
a rocker arm coupled to the road plate assembly, wherein the rocker arm undergoes a swinging motion by a downward motion of the road plate assembly caused by a vehicle passing over the road plate assembly; and
an electro-mechanical generator coupled to the rocker arm, wherein the electro-mechanical generator produces electricity by the swinging motion of the rocker arm;
a combiner circuit that combines electricity produced by each of the one or more power generation system;
a booster converter that boosts the voltage of electricity produced by each of the one or more power generation system and outputs an output voltage, the output voltage is higher than the voltage of the electricity produced by each of the one or more power generation system;
an inverter that converts the output voltage from the booster and outputs an AC voltage.

14. The power generation station of claim 13 further comprising a battery to store the AC voltage of the inverter.

15. The power generation station of claim 13, wherein each of the one or more electro-mechanical generator comprises:
a tube assembly;
a core assembly having one or more magnets on its surface; and
a pushrod having two ends, the pushrod being coupled to the core assembly on one end of the two ends and coupled to the rocker arm on the other end of the two ends,
wherein the core assembly slidably moves in and out of tube assembly undergoing a linear motion by the swinging motion of the rocker arm, and
wherein the electro-mechanical generator produces electricity by the linear motion of the core assembly.

16. The power generation station of claim 13, wherein one or more power generation system are coupled to the electro-mechanical generator by a coupler.

17. The power generation station of claim 13, wherein the electro-mechanical generator is further coupled to a flywheel.

18. The power generation station of claim 13 further comprises a hydraulic power generator coupled to the road plate assembly.
